(19) United States
(12) Patent Application Publication
(10) Pub. No.: US 2026/0258930 A1
(43) Pub. Date: Sep. 3, 2026

(54) DAMPER ASSEMBLY FOR TRAFFIC LUMINAIRES AND TRAFFIC SIGNALS

(71) Applicant: Tramec, L.L.C., Overland Park, KS (US)

(72) Inventor: Kevin M. Cornelius, Kansas City, MO (US)

(21) Appl. No.: 19/555,476

(22) Filed: Mar. 3, 2026

Related U.S. Application Data
(60) Provisional application No. 63/766,222, filed on Mar. 3, 2025.

(51) Int. Cl. F21V 15/04; F16F 15/28; F21S 8/08; F21V 17/02; F21V 23/04; F16F 15/03; G08G 1/095

(52) U.S. Cl. CPC F21V 15/04; F16F 15/28; F21S 8/086; F21V 17/02; F21V 23/0492; F16F 15/035; F16F 2230/0047; F16F 2230/18; G08G 1/095

(57) ABSTRACT

A damping device including a housing defining an interior. The damping device may include a movable component provided within the interior, wherein the movable component is movable in a linear direction along a first axis. The damping device may include a sensor configured to sense a movement of the housing. The damping device may include a controller comprising an electronic processor, the electronic processor configured to receive a signal from the sensor associated with the movement of the housing, determine a corresponding movement to dampen the sensed movement of the housing, and control the movable component according to the corresponding movement.

### CROSS-REFERENCE TO RELATED APPLICATIONS

This Application claims priority to U.S. Provisional Patent Application No. 63/766,222 filed on Mar. 3, 2025, which is incorporated by reference herein in its entirety.

### BACKGROUND

Traditionally traffic luminaires and traffic signals are mounted to poles including a substantially vertical pole. Traffic signal mounting poles include a pole, typically vertical and made of metal, designed to securely hold and support traffic lights at intersections, pedestrian crossings, and other key road points. Some traffic signal mounting poles include a substantially horizontal pole, also known as a mast arm, mounted to the first pole. The mast arm supports the traffic lights. Traffic luminaires may be mounted to a similar structure, or in some cases the same structure as the traffic signal. Traffic luminaires may also be mounted to a substantially vertical pole.

Disclosed herein, among other things, are dampers designed for use with traffic luminaires and traffic signals. In some examples, a damper is mounted to a luminaire mounting assembly for damping swaying movement of a vertical pole of the luminaire mounting assembly. In another example the damper is mounted to a traffic signal mounting assembly for mitigating flexion in a mast arm of the traffic signal mounting assembly.

One example provides a damping device for mounting to a support structure. The damping device including a housing defining an interior and a movable component provided within the interior. The movable component is movable in a linear direction along a first axis. The damping device includes a sensor configured to sense a movement of the housing and a controller including an electronic processor. The electronic processor configured to receive a signal from the sensor associated with the movement of the housing, determine a corresponding movement to dampen the sensed movement of the housing, and control the movable component according to the corresponding movement.

Another example provides a method for damping movement of a support structure, the method including receiving a first movement from the support structure at a damper connected to the support structure. The method including moving the damper in response to the first movement to define a second movement. The method including sensing the second movement of the damper with a sensor provided within a housing of the damper. The method including receiving at a controller a signal associated with the second movement from the sensor. The method including determining a third movement to dampen the sensed movement of the housing. The method including controlling a movable component within the housing according to the third movement and reducing the first movement of the support structure as a result of the third movement.

Another example provides a damping device for mounting to a support structure, the damping device including: a housing defining an interior; and multiple linear actuators provided within the housing and oriented along at least two of three axes, each linear actuator including a motor and a movable component configured to move in a linear direction along an entire length of each axis.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate aspects, examples, and features of concepts that include the claimed subject matter and explain various principles and advantages of those aspects, examples, and features.

FIGS. 1a and 1b are illustrations of support structures with dampers according to some examples.

FIG. 2 illustrates a damper from FIG. 1a according to one example.

FIG. 3 is a cross-sectional view of the damper from FIG. 2 along line III-III.

FIG. 4 illustrates a damper from FIG. 1b according to one example.

FIG. 5 is a perspective illustration of the damper from FIG. 4.

FIG. 6 is a schematic of a damper for the support structure according to yet another example.

FIG. 7 illustrates a controller according to one example.

FIG. 8 illustrates a movement sensing circuit for a support structure according to any of examples.

FIG. 9 illustrates a flow diagram for a method of damping movement for a support structure according to an example.

### DETAILED DESCRIPTION

Before any examples of the application are explained in detail, it is to be understood that the application is not limited in its application to the details of construction and the arrangement of components set forth in the following description or illustrated in the following drawings. The application is capable of other examples and of being practiced or of being carried out in various ways.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Additionally, the terms “connected” and “coupled” are not restricted to physical or mechanical connections or couplings, and can include electrical connections or couplings, whether direct or indirect. As used within this document, the word “or” may mean inclusive. As a non-limiting example, if examples in this document state that “item Z may comprise element A or B,” this may be interpreted to disclose an item Z comprising only element A, an item Z comprising only element B, as well as an item Z comprising elements A and B.

Various features and advantages of damper examples are set forth in the following text and figures. The specific configurations illustrated in the drawings are intended as examples only and other alternative configurations are possible.

Traffic signal mounting assemblies typically include traffic signals mounted on a substantially horizontal pole, referred to herein as a mast arm. The mast arm is affixed to a first pole extending primarily in the vertical direction, using any of a variety of methods. By way of example, the mast arm is bolted or welded to the first pole at one fixed end to define a joint. The first pole may be bolted to a concrete footer. The concrete footer acts as or provides a first pole mounting. While illustrated and described with respect to a traffic signal mounting assembly, it should be understood that the features and examples of dampers described herein can be implemented in any support structure including streetlights and pedestrian signals. Further, the example dampers can also be utilized in other implementations where damping is needed including signage mounting assemblies or the like.

Generally, it is expected that a traffic signal mounting assembly with a mast arm remain fixed or is relatively rigid. However, the mast arm and other components of the traffic signal mounting assembly often move. Movement is caused or affected by multiple factors. Wind is most often the cause of movement although turbulence and vibrations created by traffic can also cause movement. The weight of the mast arm along with the weight of the traffic signals and various sensors attached to the mast arm for reading traffic can affect movement. Weather conditions, for example precipitation and temperature can affect movement. Added weight from snow or ice buildup often affects movement. The movement manifests in multiple directions including vertical, horizontal, and circular directions.

Movement of the mast arm can contribute to wear at the joint and at the first pole mounting. Both the mast arm and the first pole are designed to allow an amount of flexion, however, damping the movement to minimize the amount of flexion contributes to a longer life for the traffic signal mounting assembly by decreasing fatigue on the areas discussed above.

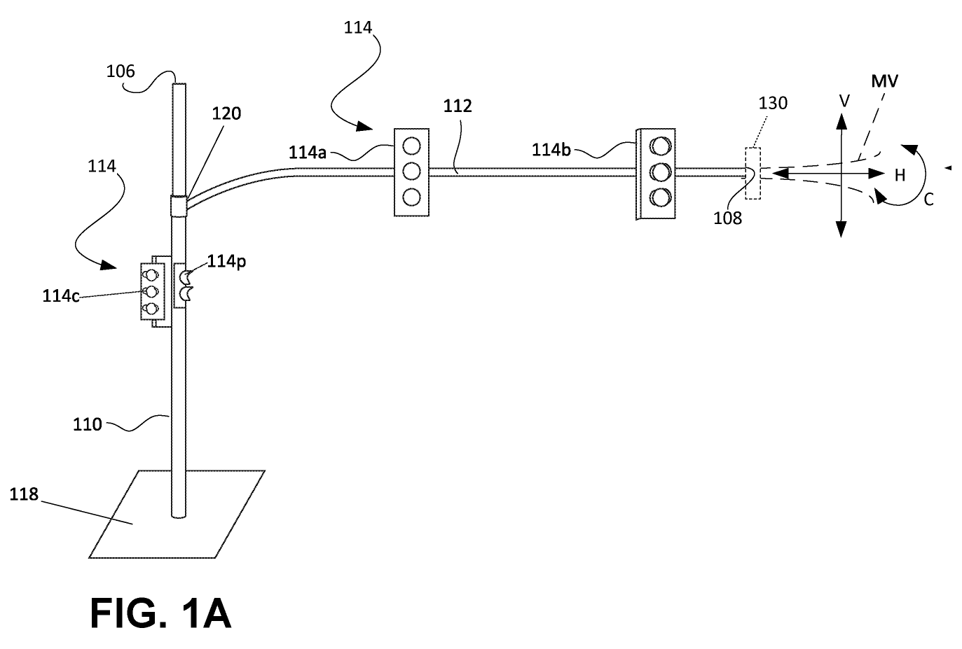

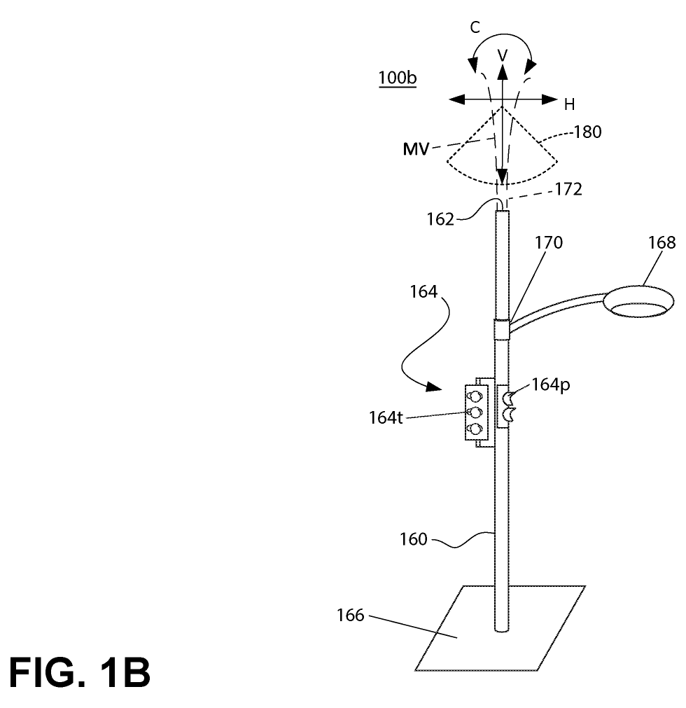

FIG. 1a is an illustration of a support structure 100a for a light mounting assembly in the form of a traffic signal mounting assembly, according to one example. In the example shown, the support structure 100a includes a first pole 110 and a second pole, or mast arm 112. The first pole 110 extends vertically from the ground, and the mast arm 112 is affixed to and cantilevers from the first pole 110 to a free end 108. A set of signals 114 may be mounted to any portion of the support structure 100a. In one example the set of signals 114 includes two traffic signals 114a, 114b mounted to the mast arm 112 and one traffic signal 114c mounted to the first pole 110. In the example shown, a pedestrian signal 114p is also attached to the first pole 110. While illustrated as four, any appropriate number of signals is contemplated. The first pole 110 may be affixed to the ground via a footer 118, by way of example a concrete footer.

In the example illustrated, the mast arm 112 is affixed to the first pole 110 at a joint 120 located above the pedestrian signal 114p. The joint 120 may allow for field assembly by telescoping the joint 120 around the first pole 110 to connect the sections (first pole 110 and mast arm 112) together. The joint 120 may be formed to provide structural integrity and allow for rotational adjustment before final fastening. By way of example, the mast arm 112 is fastened, or bolted, to the first pole 110 at the joint 120. While illustrated as extending upward at an angle from the joint 120 and then substantially horizontally between the two traffic signals 114a, 114b, it should be understood that the mast arm 112 may take any form including a truss comprising multiple beams together forming a cantilevered beam extending outwardly from the first pole 110 and above traffic. While not illustrated, other items may be mounted to the mast arm 112, including but not limited to, various sensors for monitoring traffic and weather conditions.

In the example illustrated, the mast arm 112 extends from the joint 120 to the free end 108 along a substantially horizontal axis (“HA”). Environmental factors may contribute to a movement (“MV”) of the mast arm 112 in a substantially vertical direction (“V”). While a movement MV from a driver’s perspective may be perceived as only up and down, when viewed from a perpendicular position, as indicated by an arrow (“P”), this movement MV may also be in a circular direction (“C”) and/or in a horizontal direction (“H”). The movement MV may be in any combination of directions, for example movement MV in both the vertical direction V and the horizontal direction H in a rocking motion.

The movement MV may become exaggerated depending on environmental factors previously discussed herein. For example, once started, the movement MV may be emphasized by increased or even steady wind at a certain frequency, e.g., the resonant frequency, of the first pole 110 and/or the mast arm 112. Movement MV of the first pole and/or the mast arm 112 in the horizontal H, the vertical V, or the circular directions C, over extended periods of time contribute to fatigue at both the footer 118 and the joint 120. In order to extend the life of the support structure 100a, a damping device, referred to herein as a damper, may be mounted to the support structure 100a to absorb energy and dampen vibrations associated with the movement MV.

In one example a second damper 130 is mounted to the mast arm 112. The movement MV may occur along the entirety of the mast arm 112 with the greatest displacement in any direction occurring at the free end 108. Therefore, in one non-limiting example, the first damper 130 is mounted at or near the free end 108 of the mast arm 112. The first damper 130 may be mounted to the mast arm 112 in any known manner for secure attachment. For example, the first damper 130 is bolted to the mast arm 112 with a dedicated bracket or a U-bolt. The bracket may be a two-piece bracket that encapsulates the mast arm and is bolted in place to clamp the first damper 130 to the bracket. In another example, the first damper 130 is welded to an intermediate attachment structure (not shown) which is welded to the mast arm 112. It is further contemplated that the first damper 130 is configured to be directly secured to the mast arm 112.

FIG. 1b is an illustration of a support structure 100b for a light mounting assembly in the form of a luminaire mounting assembly, according to one example. In the example shown, the support structure 100b includes a mounting pole 160. The mounting pole 160 extends vertically from the ground to a top 162. A set of signals 164 may be mounted to any portion of the support structure 100b. In one example the set of signals includes a traffic signal 164t and a pedestrian signal 164p attached to the mounting pole 160. The mounting pole 160 may be affixed to the ground via a footer 166, by way of example a concrete footer.

In the example illustrated, a streetlight 168 is affixed to the mounting pole 160 at a joint 170 located above the pedestrian signal 164p. The joint 170 may allow for field assembly by telescoping the joint 170 around the mounting pole 160 to connect the streetlight 168 to the mounting pole 160. The joint 170 may be formed similarly to the joint 120 previously described herein. It should be understood that the mounting pole 160 may also be solely for the traffic signal 164t or the pedestrian signal 164p with no streetlight 168 attached thereto. Likewise, in other examples the mounting pole 160 is solely for mounting streetlights thereto.

In the example illustrated, the mounting pole 160 extends primarily along a vertical axis (“VA”). Environmental factors may contribute to movement MV of the mounting pole 160 in a substantially horizontal direction H. While movement MV from a driver’s perspective may be perceived as only side to side, this movement MV may also be in the circular direction C. The movement MV may be in any combination of directions, for example movement MV in both the vertical direction V and circular direction C in a rocking motion. The movement MV may become exaggerated depending on environmental factors and as previously discussed herein.

In one example a second damper 180 is mounted to the top 162 of the mounting pole 160. The movement MV may occur along the entirety of the mounting pole 160 with the greatest displacement in any direction occurring at the top 162. Therefore, in one non-limiting example, the second damper 180 is mounted at or near the top 162 of the mounting pole 160. The second damper 180 may be mounted to the mounting pole 160 in any known manner for secure attachment. For example, an attachment structure 172 may extend from the top 162 and be used to couple the second damper 180 to the mounting pole 160. The second damper 180 may be welded to the attachment structure 172 which is welded to the mounting pole 160. It is further contemplated that the second damper 180 is configured to be directly secured to the mounting pole 160.

It should be understood that the first and second dampers 130, 180 may be incorporated into the support structures 100a, 100b separately or together. It is further contemplated that each damper may be individually coupled to any type of support structure (e.g., strain poles, pedestal poles).

The first and second dampers 130, 180 each include a movable component within. When the support structures 100a, 100b, or any portion of the support structure (e.g., the first pole 110, the mast arm 112, the mounting pole 160) moves in one direction, an opposite movement is initiated of the corresponding movable component. This movement dampens the movement of the first pole 110, mast arm 112, or mounting pole 160 to which the corresponding damper 130, 180 is connected and therefore dampen any movement of the support structures 100a, 100b. This results in reduce wear and stress of the support structures 100a, 100b and corresponding components.

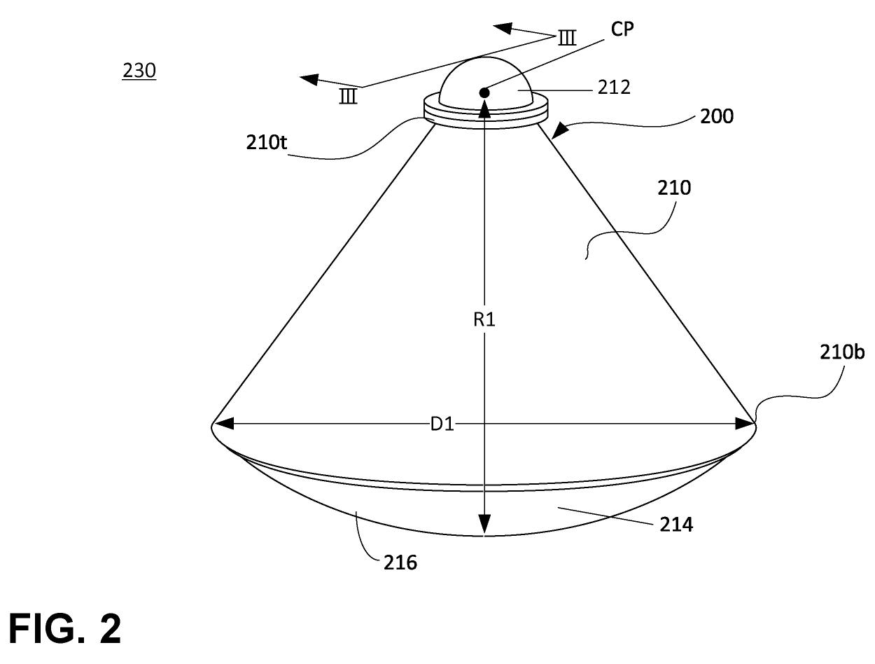

FIG. 2 illustrates a damper 230, (e.g., the second damper 180 of FIG. 1b) according to one example. In the example shown, the damper 230 includes a housing 200 having a conical section 210 extending between a socket 212 and a cover 214. The socket 212 is coupled to and closes a top 210t of the conical section 210. The cover 214 is coupled to and closes a bottom 210b of the conical section 210. The cover 214 may be in the form of a spherical cap 216. The spherical cap 216 having a first radius (“R1”) originating at a center point (“CP”) of the socket 212. In one example, the center point CP and the top 210t are aligned or located within the same plane. The first radius R1 may range from 7 inches (17.8 cm) to 12 inches (30.5 cm). In one example the first radius R1 is equal to 10.5 inches (26.7 cm). The spherical cap 216 defines a first diameter (“D1”). The first diameter D1 is dependent on the structure and size of the support structure 100b and elements connected to the support structure 100b (FIG. 1b). By way of example, the larger the support structure 100b, the larger the first diameter D1. In one non-limiting example the first diameter D1 ranges from 10 inches (25.4 cm) to 14 inches (35.6 cm). In one non-limiting example the first diameter D1 is equal to 12 inches (30.5 cm).

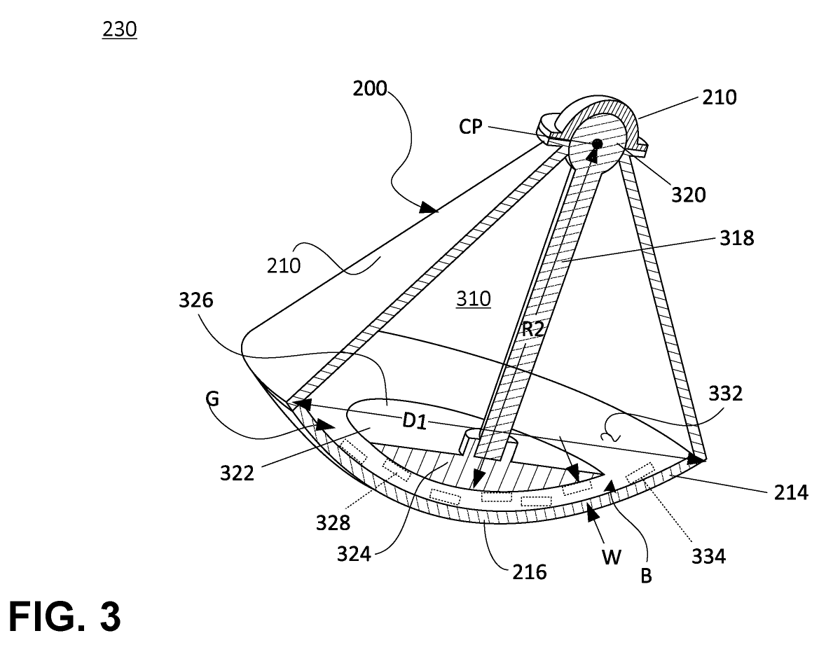

FIG. 3 illustrates the damper 230 in cross-section cut in half along line III-III of FIG. 2 showing an interior 310 of the damper 230 with a movable component disposed therein. A pendulum 318 extends from a ball 320 to a bob 322 a length equal to a second radius (“R2”). A center point of the ball 320 is concentric with the center point CP of the socket 212 when assembled. A mass of the bob 322 is also dependent on the structure and size of the support structure 100b (FIG. 1b) to which it is mounted. In one non-limiting example, the bob 322 has a mass ranging from 5 lbs (2.3 kg) to 20lbs (9.1 kg). In one non-limiting example the mass is 10 lbs (4.5kg). The ball 320 is housed in the socket 212 and the bob 322 can swing freely within the damper 230. The bob 322 may be formed with a spherical shape as illustrated and concentric with respect to the spherical cap 216. The second radius R2 is smaller than the first radius R1 leaving a gap (“G”) of width W that remains constant when the pendulum 318 swings. In other words, the bob 322 is configured to swing concentrically with respect to the spherical cap 216 whilst maintaining the gap G.

In one example, the bob 322 is formed from different types of materials. A first material may define a bulk portion 324 of the bob 322 while an exterior portion 326 of the bob 322 is formed from a second material different than the first material. The second material may be a non-ferrous material, (e.g., aluminum), while the first material may be a ferrous material (e.g., low-carbon steel) with a higher density than aluminum providing the needed, or predetermined, mass for the bob 322. The first material may also be a non-ferrous material, having non-magnetic properties and lower density in comparison to ferrous materials which have magnetic properties.

In an additional example, an interior surface 332 of the spherical cap 216 includes a first set of magnets 334. The first set of magnets 334 are spaced from each other at a predetermined distance along the interior surface 332 of the spherical cap 216. The first set of magnets 334 may include magnets having alternating polarity or the same polarity. The first set of magnets 334 produce a magnetic field (“B”) through which the bob 322 swings.

Non-ferrous materials are susceptible to generating eddy currents when moving through a magnetic field because they are good conductors of electricity. For example, when movement MV occurs in the mounting pole 160 the pendulum 318 swings and in turn eddy currents are induced in the non-ferrous material of the bob 322 from the changing magnetic field produced relative to the bob 322 when the bob 322 swings. The generated eddy currents result in an electromagnetic force (EMF) for damping the movement. The strength of the eddy currents depends on the electrical conductivity (σ) of the bob 322. When formed from non-ferrous materials (e.g., aluminum, copper, brass) the electrical conductivity can be relatively high (1×10⁷ < σ < 7×10⁷).

In another example, the bob 322 is formed entirely from a non-ferrous material and the exterior portion 326 includes a second set of magnets 328. The second set of magnets 328 may be spaced from each other a predetermined distance. The second set of magnets 328 may include magnets having alternating polarity or the same polarity.

In one example the first set of magnets 328 and the second set of magnets 334 have opposing polarities causing an attraction between the sets of magnets 328, 334 and resulting in a dampening of the movement MV as described previously herein. For example, if the first pole 110 moves left, the housing 200 also moves left while the pendulum remains stationary. However, relative to the housing 200, the pendulum moves to the right thereby passing through the magnetic field B produced by the first set of magnets 334, induces eddy currents in non-ferrous material of the bob 322, and the movement is dampened by the resulting interaction between the first set of magnets 334 and the eddy currents as well as the second set of magnets 328.

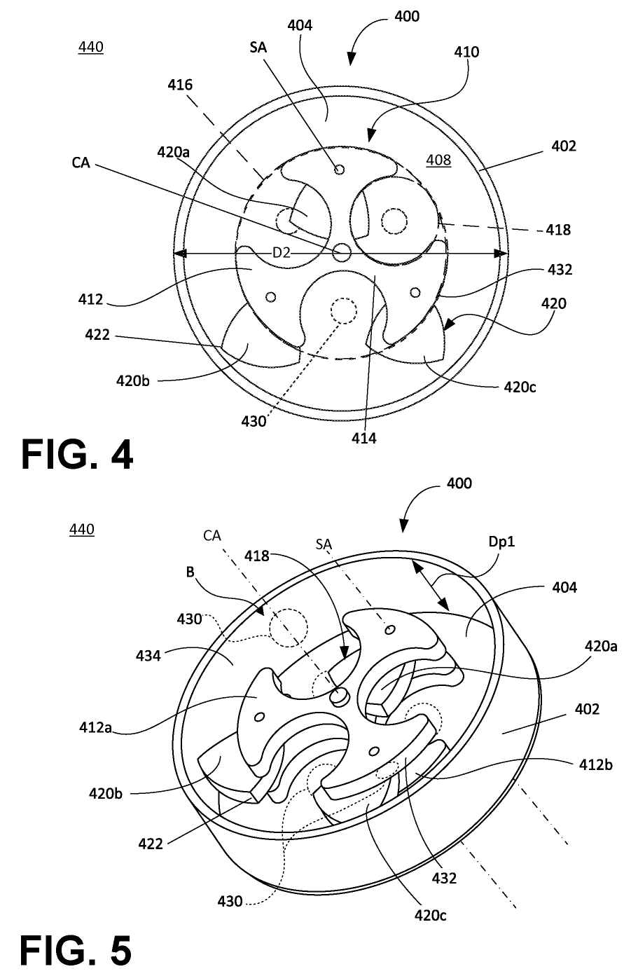

FIG. 4 illustrates a damper 440 (e.g., the first damper 130 of FIG. 1a) according to an example showing an interior 408 of the damper 440 with a movable component disposed therein. The damper 440 includes a housing 400. The damper 440 may be configured to be mounted to the support structure 100a similarly to the first damper 130 previously described herein. The housing 400 may be configured to be mounted to the mast arm 112 (FIG. 1a). In particular, one of the first cap end 404, the second cap end, or the wall 402 may be configured for mounting to the free end 108 (FIG. 1a) depending on the structure and size of the support structure 100 (FIG. 1). In one example, when mounted to the mast arm 112 (FIG. 1a), the central axis CA of the housing 400 and the horizontal axis HA (FIG. 1a) are aligned. This alignment allows for damping in the vertical and the circular directions V, C (FIG. 1a). In another example, when mounted to the mast arm 112 (FIG. 1a), the central axis CA is parallel to the ground. The orientation of the damper 440 depends on the environmental factors and the elements of the support structure 100 (FIG. 1a).

The housing 400 may be defined by a wall 402 extending from a first cap end 404 about a central axis (“CA”). The wall 402 may have a circular shape such that the housing 400 has a cylindrical shape. The wall 402 extends between the first cap end 404 and a second cap end (removed to illustrate the interior 408 of the housing 400). Together the wall 402, the first cap end 404, and the second cap end enclose the interior 408. The wall 402 may define a second diameter (“D2”). Similarly to the first diameter D1 with respect to the damper 230, dimensions associated with the second diameter D2 also depend on the structure and size of the support structure 100 (FIG. 1a). In one non-limiting example the second diameter D2 ranges from 10 inches (25.4 cm) to 20 inches (50.8 cm). In one non-limiting example the second diameter D2 is equal to 19 inches (48.3 cm).

A Ferris wheel assembly 410 is disposed within the interior. Like a typical Ferris wheel, the Ferris wheel assembly 410 includes a main axis (e.g., the central axis CA) and multiple secondary axes (“SA”) circumscribing the central axis CA. The Ferris wheel assembly 410 includes a set of blades 412 rotatable about the central axis CA of the housing 400. The set of blades 412 may bea Y-shaped blade with three spokes 414, or arms, each defining a corresponding secondary axis (“SA”) provided proximate a distal end 432 of the corresponding spoke 414. The set of blades 412 may be formed in a substantially circular shape 416 with three smaller circles 418 removed to define the Y-shape. The Ferris wheel assembly 410 may be affixed to the cap end 404 by a low friction bearing, by way of example a ball bearing, a roller bearing, a pillow block bearing, or similar, for free movement.

The Ferris wheel assembly 410 may include a set of counterweights 420 mounted at each secondary point axis SA to define secondary rotational parts of the Ferris wheel assembly 410. In the example illustrated, the set of counterweights 420 includes a first counterweight 420a, a second counterweight 420b, and a third counterweight 420c each having an oblong shape. The oblong shape being, by way of example, a Reuleaux triangle shape with three vertices 422. Each counterweight 420a, 420b, 420c may be mounted proximate one of the vertices 422 so as to hang freely from the secondary point axis SA. While three counterweights are illustrated one or two counterweights are also contemplated. Further, similarly to a Ferris wheel, additional counterweights are also contemplated depending on the structure and size of the support structure 100 (FIG. 1a).

FIG. 5 is a perspective illustration of the damper 440 of FIG. 4. The wall 402 extends from the cap end 404 a first depth (“Dp1”). The first depth Dp1 also depends on the structure and size of the support structure 100 (FIG. 1a). In one non-limiting example the first depth Dp1 ranges from 6 inches (15.2 cm) to 7 inches (17.7 cm). In one non-limiting example the first depth Dp1 is equal to 6.2 inches (15.7 cm).

It can be more easily seen that the set of blades 412 are two Y-shaped blades 412a, 412b, affixed to each other so as to rotate together about the central axis CA. The two Y-shaped blades 412a, 412b are spaced from each other such that the set of counterweights 420 swing freely therebetween. While two Y-shaped blades 412a, 412b are illustrated, only one Y-shaped blade 412 is also contemplated, where the set of counterweights 420 is mounted to cantilever from each blade. Additionally, the two Y-shaped blades 412a, 412b may each have a Y-shape as illustrated or each have a different shape as described previously herein.

The set of counterweights 420 define a total mass. The total mass depends on the structure and size of the support structure 100 (FIG. 1a). In one non-limiting example the total mass ranges from 9 lbs (4.1 kg) to 15 lbs (6.8 kg). In one non-limiting example the total mass of the set of counterweights 420 is 12 lbs (5.5 kg).

In one example, the first counterweight 420a has a mass greater than the second and third counterweights 420b, 420c. By way of example the second and third counterweights 420b, 420c have similar or equal masses with respect to one another. The sum of the masses for the second and third counterweights 420b, 420c may be less than the mass of the first counterweight 420a. For example, the first counterweight 420a may have a mass of 8 lbs (3.6 kg) and the second and third counterweights 420b, 420c each have a mass of 2 lbs (0.9 kg).

In another example, the sum of the masses for the second and third counterweights 420b, 420c may be greater than the mass of the first counterweight 420a. For example, the first counterweight 420a may have a mass of 5 lbs (2.3 kg) and the second and third counterweights 420b, 420c each have a mass of 4 lbs (1.8 kg).

It is further contemplated that the sum of the masses for the second and third counterweights 420b, 420c may be equal to the mass of the first counterweight 420a. For example, the first counterweight 420a has a mass of 6 lbs (2.8 kg) and the second and third counterweights 420b, 420c each have a mass of 3 lbs (1.4 kg).

In yet another example, the first and third counterweights 420a, 420b each have a mass greater than the third counterweight 420c. For example, the first and third counterweights 420a, 420b each have a mass of 4.5 lbs (2.0 kg) and the third counterweight 420c has a mass of 4 lbs (1.8 kg).

Additionally, all three counterweights 420a, 420b, 420c may have similar or equal masses with respect to each other. For example, each counterweight 420a, 420b, 420c is 4 lbs (1.8 kg).

In one example, the set of blades 412 are formed from different types of materials. A first material may define a bulk portion of the set of blades while an exterior portion of the set of blades is formed from a second material different than the first material. The second material may be a non-ferrous material, (e.g., aluminum), while the first material may be a ferrous material (e.g., low-carbon steel) with a higher density than aluminum. The first material may also be a non-ferrous material, having non-magnetic properties and lower density in comparison to ferrous materials which have magnetic properties.

In another example, the set of blades 412 are formed entirely from a non-ferrous material (e.g., aluminum, copper, lead, or tin) and the set of counterweights 420 are formed from a ferrous material. Non-ferrous materials are susceptible to generating eddy currents when moving through a magnetic field because they are good conductors of electricity. When movement occurs in the mast arm 112 the Ferris wheel assembly 410 rotates and in turn eddy currents may be induced in the set of blades 412 from the changing magnetic field produced relative to the set of blades 412. The generated eddy currents result in an electromagnetic force (EMF) for damping the movement. The strength of the eddy currents depends on the electrical conductivity (σ) of the set of blades 412. When formed from non-ferrous materials (e.g., aluminum, copper, brass) the electrical conductivity can be relatively high (1×10⁷ < σ < 7×10⁷). The set of counterweights 420 may be formed from non-ferrous or ferrous material depending on the material from which the set of blades 412 is formed.

A set of magnets 430 (illustrated in dashed line) may be mounted to various parts of the housing 400 and/or Ferris wheel assembly 410. In one example the set of magnets 430 is mounted to the first cap end 404. In addition to or in place of the magnets disposed on the first cap end 404, the set of magnets 430 may include magnets mounted to the second cap end (not illustrated). In another example, the set of magnets 430 is mounted to a distal end 432 of the spokes 414. In addition to or in place of the magnets, disposed on the distal end 432 the set of magnets 430 may include magnets mounted to an interior surface 434 of the wall 402.

In another example, both the set of blades 412 and the housing 400 are formed from non-ferrous material and the set of magnets 430 are mounted to an exterior of the housing 400. The eddy currents generated in both the set of blades 412 and the housing 400 interact with the set of magnets 430 and each other in order to dampen the movement.

In another example, the set of blades 412 is formed from ferrous material. In this example, the movement of the mast arm 112 is dampened by the attraction between the set of blades 412 and the set of magnets 430.

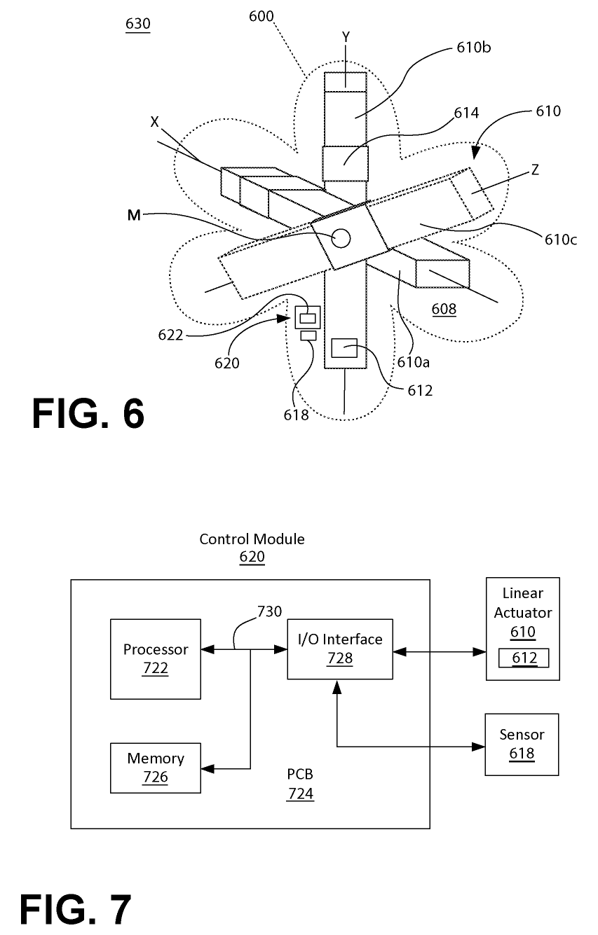

FIG. 6 is a schematic of a damper 630 according to another example showing an interior 608 of the damper 630 with a movable component disposed therein. The damper 630 includes a housing 600 illustrated in dashed line. The damper 630 may be configured to be mounted to the support structures 100a, 100b similarly to the dampers 130/180 previously described herein. The housing 600 may have an organic or multi-axis shape. In the illustrated example the housing is oriented along three axes (X, Y, Z) perpendicular to each other and extending through an interior 1008 of the housing 600. The X and Z axes form a horizontal plane within the housing 600. A feature, by way of example a set of linear actuators 610, including at least one movable component is provided within the housing 600. The set of linear actuators 610 may be a single linear actuator 610 oriented along one of the axes (e.g., the X-axis), two linear actuators 610a, 610b oriented along two of the axes (e.g., the X-axis and the Y-axis), or three linear actuators 610a, 610b, 610c oriented along all three axes (e.g., the X-axis, the Y-axis, and the Z-axis).

Each linear actuator in the set of linear actuators 610 may include a motor 612 and a movable component, a sled 614 (e.g., a moving sled comprising a linear bearing and guide) affixed to, by way of example, a lead screw (not shown). While a sled linear actuator is illustrated, any appropriate linear actuator is contemplated (e.g., a maglev actuator, a caged ball bearing linear actuator, a screw linear actuator, or the like). The set of linear actuators 610 are oriented such that they are close to each other without intersecting with each other. This orientation enables the associated sleds 614 to slide along the corresponding X, Y, and Z axes an entire length of each linear actuator 610a, 610b, 610c.

In the example illustrated, a mass (“M”) is affixed to each sled 614. A first sensor 618, by way of example a gyroscope and/or an accelerometer, is provided in the housing 600. The first sensor 618 may be located in any suitable location so as to sense a movement of the damper 630. The first sensor 618 may be configured to sense movement, direction, and/or speed of the damper 630.

A controller 620 is provided in the housing 600 to interpret readings from the first sensor 618 and control the set of linear actuators 610. The first sensor 618 is configured to communicate sensed movement of the damper to the controller 620. The controller 620 is configured to determine a corresponding action for the linear actuators 610a, 610b, 610c to offset the sensed movement. The controller 620 may include an electronic processor 622 electrically and/or communicatively coupled to the set of linear actuators 610 by various known elements and configured to control the set of linear actuators 610. While only one controller 620 is illustrated, each linear actuator may include a dedicated controller 620, electronic processor 622, and/or the first sensor 618.

The electronic processor 622 may be configured to instruct the motor 612 to initiate an opposing movement of the masses M by turning the lead screw and to move a rod and in turn the sled 614 according to the sensed movement of the damper 1030. For example, if the sensed movement is to the right along the X-axis, then instructions provided may include moving the sled 614 of the linear actuator 610a to the left along the X-axis to counter the sensed movement. This opposing movement of the masses M to the sensed movement of the damper 630 (e.g., at the free end 108 (FIG. 1a) of the mast arm 112 (FIG. 1a)) is intended to offset movement of the mast arm 112 and reduce associated harmonics, bringing the mast arm 112 back to a steady state of rest.

FIG. 7 illustrates the controller 620 according to one example. The controller 620 may include a printed circuit board (PCB) 724 with the electronic processor 722 (e.g., a microprocessor, application specific integrated circuit, etc.), a memory 726, and an input/output interface 728.

The memory 726 may include one or more non-transitory computer-readable media and includes at least a program storage area and a data storage area. The program storage area and the data storage area can include combinations of different types of memory, such as read-only memory (“ROM”), random access memory (“RAM”), electrically erasable programmable read-only memory (“EEPROM”), flash memory, or other suitable memory devices. The electronic processor 722 is coupled to the memory 726 and the input/output interface 728. The electronic processor 722 sends and receives information (for example, from the memory 726 and/or the input/output interface 728) and processes the information by executing one or more software instructions or modules, capable of being stored in the memory 726, or another non-transitory computer readable medium. The software can include firmware, one or more applications, program data, filters, rules, one or more program modules, and other executable instructions. The electronic processor 722 is configured to retrieve from the memory 726 and execute, among other things, software for performing methods as described herein.

The input/output interface 728 transmits and receives information from devices external to the controller 620 (e.g., the first sensor 618 and/or the linear actuator 610) and components integral with the controller 620 (e.g., the electronic processor 722 and/or the memory 726) via a bus 730. While illustrated as separate from the controller 620, the first sensor 618 may be integral with the controller 620.

By way of example, sensed movement of the damper 630 is provided to the electronic processor 722 via the input/output interface 728 from the first sensor 618. The electronic processor 722 determines a corresponding movement that will dampen or lessen the sensed movement. Instructions are then provided to the set of linear actuators 610, and in particular the corresponding motor 612, accordingly.

It should be understood that the damper 630 and the controller 620 may include additional components than those illustrated in FIGS. 6 and 7 and in various configurations. For example, in some examples, the damper 630 includes multiple controllers 620. In some examples the controller 620 includes multiple electronic processors 722, multiple memories 726, multiple input/output interfaces 728, or a combination thereof.

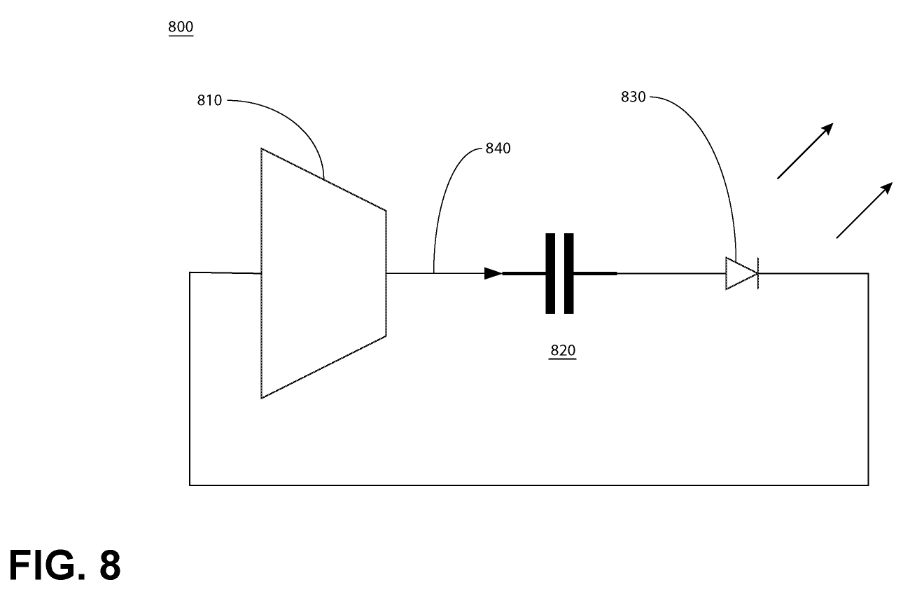

FIG. 8 illustrates a movement circuit 800 according to an example of the disclosure herein. The movement circuit 800 may be mounted to or integrated with any of the dampers disclosed herein. The movement circuit 800 includes a second sensor 810 (e.g., a piezo electric generator), a capacitor 820, and an indicator 830. In one example, the second sensor 810 produces a signal 840 when movement within the damper (e.g., damper 130, 180, 230, 440, 630) occurs. Specifically, when movement of the movable component (e.g., the pendulum 218, the Ferris Wheel Assembly 410, the sled 614) within the damper occurs, the signal 840 is produced. The signal 840 is provided in the form of an electric voltage to the indicator 830, by way of example a low-current draw LED, that turns on when the damper 130, 180 (FIGS. 1a, 1b) is moving. The capacitor 820 is provided to smooth the signal so as to prevent flashing of the indicator 830. The effectiveness of the damper can therefore be visually indicated by the indicator 830 switching from off to on (arrows). An inspector can therefore visually check the damper from ground level.

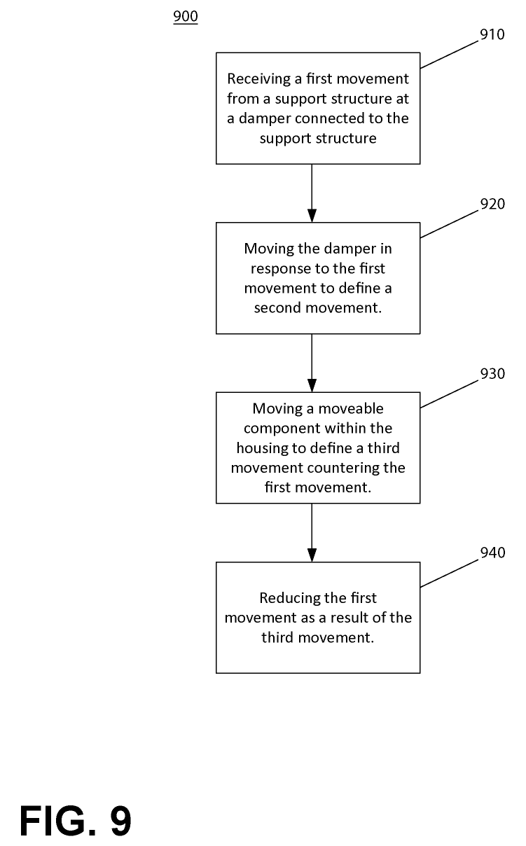

FIG. 9 is a flow chart illustrating a method 900 for damping movement of the support structure 100a, 100b as described herein. In one example the method is executed automatically due to the mass distribution as described herein. In another example the method is executed by the controller 620 with the electronic processor 622 and associated memory 626 storing instructions which, when executed by the electronic processor 622, cause the controller 620 to perform the steps of the method.

The method 900 includes at block 910 receiving a first movement (e.g., the movement MV from FIGS. 1a. 1b.) from the support structure 100a, 100b (e.g., via the mast arm 112, the mounting pole 160) at a damper (e.g., damper 130, 180, 230, 440, 630).

At block 920 the method 900 includes moving the damper connected to the support structure 100a, 100b in response to the first movement to define a second movement. The second movement is specific to the movement of the damper itself. For example, the second movement refers to the movement of the housing (e.g., housing 200, housing 400, housing 600) of the damper. It should be understood that the second movement and the first movement may be the same or similar in direction.

At block 930 the method 900 includes moving a moveable component (e.g., pendulum 218, Ferris Wheel Assembly 410, sled 614) within the housing to define a third movement, e.g., the opposing movement, countering the first movement. In examples including a non-ferrous conductive material, movement through a magnetic field causes a changing magnetic flux that induces circulating eddy currents. The eddy currents create their own opposing magnetic field which produces a drag force which adds to the opposing movement.

At block 940 the method 900 includes reducing the first movement as a result of the third movement.

The method 900 may include moving the movable component of the damper in a circular direction. For example, swinging the pendulum 218, rotating the Ferris Wheel Assembly 410, sliding the sled 614.

The method 900 may include moving the moveable component of the damper along one of three axes. For example, instructing the sled 614 to move, via the controller 710, in an opposing movement along the X-axis, the Y-axis, or the Z-axis. In some examples multiple sleds 614 are instructed to move along two or all three of the axes.

The method 900 may include moving the moveable component of the damper in a linear direction. For example, along one of three axes in response to first sensing the second movement with the first sensor 618 located within the housing 600.

The method 900 may include moving the mass M affixed to the sled 614 in response to sensing the second movement.

The method 900 may include sensing the third movement with the second sensor 810 and producing a signal indicating movement of the moveable component (e.g., the pendulum 318, the set of blades 412, the sled 614) of the damper. The signal may be in the form of the electric voltage provided to the indicator 830 as described herein such that a light is turned on/off when movement is sensed.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” or “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Additionally, unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some examples, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations, for example, collectively. To reiterate, those electronic processors and processing may be distributed.

It should be understood that any combination of the examples described herein is contemplated. Any of the dampers described herein may be combined with features of other dampers described herein.

Systems, methods, and devices in accordance with the present disclosure may take any one or more of the following configurations.

Clause 1. A damping device for mounting to a support structure, the damping device comprising: a housing defining an interior; a movable component provided within the interior, wherein the movable component is movable in a linear direction along a first axis; a sensor configured to sense a movement of the housing; and a controller comprising an electronic processor, the electronic processor configured to: receive a signal from the sensor associated with the movement of the housing, determine a corresponding movement to dampen the sensed movement of the housing, and control the movable component according to the corresponding movement.

Clause 2. The damping device of clause 1, wherein the movable component is associated with a linear actuator.

Clause 3. The damping device of any preceding clause, wherein the movable component comprises a first movable component movable along the first axis and a second movable component movable along a second axis perpendicular to the first axis.

Clause 4. The damping device of any preceding clause, wherein the first and second movable components are each associated with a linear actuator.

Clause 5. The damping device of any preceding clause, further comprising a third movable component movable along a third axes perpendicular to the first axis and the second axis.

Clause 6. The damping device of clause 5, wherein the first, the second, and the third movable components are each associated with a linear actuator.

Clause 7. The damping device of any preceding clause, further comprising a mass affixed to the movable component.

Clause 8. The damping device of any preceding clause, further comprising a movement circuit including a second sensor configured to sense a movement of the movable component and provide a signal indicative of the movement.

Clause 9. The damping device of clause 8, wherein the second sensor is a piezo electric generator.

Clause 10. The damping device of clause 8, wherein the signal is a visual signal comprising turning a light on and/or off when movement is sensed.

Clause 11. A method for damping movement of a support structure, the method comprising: receiving a first movement from the support structure at a damper connected to the support structure; moving the damper in response to the first movement to define a second movement; sensing the second movement of the damper with a sensor provided within a housing of the damper; receiving at a controller a signal associated with the second movement from the sensor; determining a third movement to dampen the sensed movement of the housing; controlling a movable component within the housing according to the third movement; and reducing the first movement of the support structure as a result of the third movement.

Clause 12. The method of clause 11, wherein controlling the movable component comprises moving a first movable component along a first axis and moving a second movable component along a second axis perpendicular to the first axis.

Clause 13. The method of clause 12, further comprising moving a third movable component along a third axes perpendicular to the first axis and the second axis.

Clause 14. The method of clause 11, wherein controlling the movable component comprises moving a mass affixed to the movable component.

Clause 15. The method of clause 11, wherein controlling the movable component comprises moving a linear actuator along one of a first, second, or third axis.

Clause 16. The method of clause 15, further comprising moving a mass affixed to the linear actuator.

Clause 17. The method of clause 15, further comprising sensing the third movement with a sensor associated with the damper and producing a signal indicative of the first movement.

Clause 18. The method of clause 17, wherein producing a signal indicative of the first movement comprises turning a light on/off when movement is sensed.

Clause 19. A damping device for mounting to a support structure, the damping device comprising: a housing defining an interior; and multiple linear actuators provided within the housing and oriented along at least two of three axes, each linear actuator including a motor and a movable component configured to move in a linear direction along an entire length of each axis.

Clause 20. The damping device of clause 19 further comprising a sensor configured to sense a movement of the housing; and a controller comprising an electronic processor, the electronic processor configured to: receive a signal from the sensor associated with the movement of the housing, determine a corresponding movement to dampen the sensed movement of the housing, and control each movable component according to the corresponding movement.

What is claimed is:

1. A damping device for mounting to a support structure, the damping device comprising:
a housing defining an interior;
a movable component provided within the interior, wherein the movable component is movable in a linear direction along a first axis;
a sensor configured to sense a movement of the housing; and
a controller comprising an electronic processor, the electronic processor configured to:
receive a signal from the sensor associated with the movement of the housing,
determine a corresponding movement to dampen the sensed movement of the housing, and
control the movable component according to the corresponding movement.

2. The damping device of claim 1, wherein the movable component is associated with a linear actuator.

3. The damping device of claim 1, wherein the movable component comprises a first movable component movable along the first axis and a second movable component movable along a second axis perpendicular to the first axis.

4. The damping device of claim 3, wherein the first and second movable components are each associated with a linear actuator.

5. The damping device of claim 3, further comprising a third movable component movable along a third axes perpendicular to the first axis and the second axis.

6. The damping device of claim 5, wherein the first, the second, and the third movable components are each associated with a linear actuator.

7. The damping device of claim 1, further comprising a mass affixed to the movable component.

8. The damping device of claim 1, further comprising a movement circuit including a second sensor configured to sense a movement of the movable component and provide a signal indicative of the movement.

9. The damping device of claim 8, wherein the second sensor is a piezo electric generator.

10. The damping device of claim 8, wherein the signal is a visual signal comprising turning a light on and/or off when movement is sensed.

11. A method for damping movement of a support structure, the method comprising:
receiving a first movement from the support structure at a damper connected to the support structure;
moving the damper in response to the first movement to define a second movement;
sensing the second movement of the damper with a sensor provided within a housing of the damper;
receiving at a controller a signal associated with the second movement from the sensor;
determining a third movement to dampen the sensed movement of the housing;
controlling a movable component within the housing according to the third movement; and
reducing the first movement of the support structure as a result of the third movement.

12. The method of claim 11, wherein controlling the movable component comprises moving a first movable component along a first axis and moving a second movable component along a second axis perpendicular to the first axis.

13. The method of claim 12, further comprising moving a third movable component along a third axes perpendicular to the first axis and the second axis.

14. The method of claim 11, wherein controlling the movable component comprises moving a mass affixed to the movable component.

15. The method of claim 11, wherein controlling the movable component comprises moving a linear actuator along one of a first, second, or third axis.

16. The method of claim 15, further comprising moving a mass affixed to the linear actuator.

17. The method of claim 15, further comprising sensing the third movement with a sensor associated with the damper and producing a signal indicative of the first movement.

18. The method of claim 17, wherein producing a signal indicative of the first movement comprises turning a light on/off when movement is sensed.

19. A damping device for mounting to a support structure, the damping device comprising:
a housing defining an interior; and
multiple linear actuators provided within the housing and oriented along at least two of three axes, each linear actuator including a motor and a movable component configured to move in a linear direction along an entire length of each axis.

20. The damping device of claim 19 further comprising a sensor configured to sense a movement of the housing; and
a controller comprising an electronic processor, the electronic processor configured to:
receive a signal from the sensor associated with the movement of the housing,
determine a corresponding movement to dampen the sensed movement of the housing, and
control each movable component according to the corresponding movement.
